(19) United States
(12) Patent Application Publication
(10) Pub. No.: US 2018/0084812 A1
(43) Pub. Date: Mar. 29, 2018

(54) METHOD FOR MANUFACTURING OF SOY SAUCE USING BAMBOO SALTS

(71) Applicant: KOREA BAMBOO SALT CORPORATION, Gyeongsangnam-do (KR)

(72) Inventor: Ja Min CHA, Gyeongsangnam-do (KR)

(73) Assignee: KOREA BAMBOO SALT CORPORATION, Gyeongsangnam-do (KR)

(21) Appl. No.: 15/279,337

(22) Filed: Sep. 28, 2016

(30) Foreign Application Priority Data
Sep. 26, 2016 (KR) 10-2016-0123362

(51) Int. Cl. A23L 27/50; A23L 11/00; A23L 23/00

(52) U.S. Cl. CPC A23L 27/50; A23V 2002/00; A23L 23/00; A23L 11/09

(57) ABSTRACT

The present disclosure relates to a method for manufacturing soy sauce. More particularly, the present disclosure relates to a method for manufacturing soy sauce using bamboo salts. The method according to the present disclosure includes: steaming small beans for 3˜7 hours; cooling the steamed small beans at a temperature of 20˜40° C., after spreading the steamed small beans; mixing the cooled small beans with koji mold and peanut powder; forming a fermented soybean lump using the small beans mixed with the koji mold and the peanut powder, and tying an external portion of the fermented soybean lump using a rice straw; drying the formed fermented soybean lump in sunshine; fermenting the dried fermented soybean lump for 24˜48 hours while maintaining a humidity of 15˜35% and a temperature of 20˜40° C.; manufacturing a fermentation liquor by putting the fermented soybean lump in a jar, and by soaking the fermented soybean lump to be totally submerged in a mixed liquor of 100 parts by weight of bamboo salt water, 20˜40 parts by weight of Ulmus davidiana water, 15˜25 parts by weight of jujube fermentation liquor, and 5˜15 parts by weight of red ginseng extract; and completing the soy sauce, by separating the fermented soybean lump from the fermentation liquor, filtering floating matters, and by heating the fermentation liquor to be reduced by 70˜90% of an initial volume. The method for manufacturing soy sauce using bamboo salts according to an exemplary embodiment of the present disclosure may enhance taste and flavor of the soy sauce. In addition, the soy sauce according to an exemplary embodiment of the present disclosure has high content of necessary amino acid in the soy sauce, and may fundamentally prevent generation of cancer-causing agent.

### CROSS-REFERENCE TO RELATED APPLICATIONS

Pursuant to 35 U.S.C. § 119 (a), this application claims the benefit of earlier filing date and right of priority to Korean Patent Application No. 10-2016-0123362, filed on Sep. 26, 2016, contents of which are hereby incorporated by reference in its entirety.

### TECHNICAL FIELD

The present disclosure relates to a method for manufacturing soy sauce. More particularly, the present disclosure relates to a method for manufacturing soy sauce using bamboo salts.

### DISCUSSION OF RELATED ART

The soy sauce refers to a sauce made by a process where a fermented soybean lump is formed using beans, the fermented soybean lump is soaked in salt water, and the juice is decocted. The soy sauce may be categorized into thick soy sauce, medium soy sauce, and mild soy sauce. Since their colors and the extent of sweet and salty taste are all different, they are used for food in different ways. The mild soy sauce, which has been matured for 1˜2 years, is used for boiling a soup. The medium soy sauce is used for seasoning the vegetables. The thick soy sauce, which has been matured more than 5 years, is sweet and brown-colored so as to be used for making cookies.

The soy sauce contains lactobacillus such as yeast fungus and Bacillus natto. In addition, the soy sauce functions to supply protein, amino acid, and salinity for nutrition. The soy sauce may soften blood vessels to help blood circulation and remove impurities in the blood vessels to accelerate synthesis of Vitamins in the body. Furthermore, the methionine contained in the soy sauce has outstanding effects in detoxication of alcohol and nicotine, and in removing toxic substance in the body.

As a Korean traditional food, the soy sauce is a representative fermented food, which contains nutritional contents and bioactive substances such as protein, sugars, carotene, and vitamins. However, the soy sauce manufactured by the conventional method has problems of having unstable black color, strong smell of the fermented soybean lump, and strong salty taste and flavor. Therefore, researched for improving these problems are required.

In relation to this, Registered Patent No. 928123 (A method for manufacturing soy sauce and soybean paste) has been suggested. This reference has an advantage of providing modern taste and flavor by adding sweet taste using dried persimmons and jujubes. However, there is still a possibility that the original taste of the persimmons and the jujubes do not harmonize with the soy sauce to cause rather a resistance of people.

Meanwhile, the TN index (Total Nitrogen index), which an index for figuring out how much nitrogen protein is contained in the soy sauce, is used as a measure to evaluate a degree of fermentation of the soy sauce. As the TN index becomes higher, the content of amino acid becomes larger, such that the flavor of the soy sauce is enhanced. When the TN index is 1.0, the soy sauce is categorized as a standard class. When the TN index is more than 1.3, the soy sauce is categorized as a premium class. When the TN index is more than 1.5, the soy sauce is categorized as the highest class.

As mentioned in the above, when the TN index (that is, the content of amino acid) in the soy sauce is increased, the flavor of the soy sauce is enhanced. Researches have been conducted based on this fact. An acid hydrolyzed soy sauce is a soy sauce made by a process where an amino acid is obtained by hydrolysis of water and edible hydrochloric acid, the amino acid is neutralized using alkali such as sodium chloride and fermented by being soaked in the salt water. The acid hydrolyzed soy sauce has higher content of amino acid and short manufacturing period in comparison with the conventional soy sauce, and therefore has been manufactured as a main item by some manufactures.

However, usage of the acid hydrolyzed soy sauce has been rapidly declined, as it was knows a fact that ‘3-MCPD (3-chloro-1,2-proapnediol)’, which is well known as a cancer-causing agent, is generated during the process to obtain the amino acid by hydrolysis of water and edible hydrochloric acid.

In relation to this, Registered Patent No. 203917 (a method for manufacturing acid hydrolyzed soy sauce in which contents of 3-chloro-1,2-proapnediol is minimized) has been suggested. This reference has an advantage of reducing generation of 3-MCPD using ‘dilute hydrochloric acid’. However, there is still a problem in that the generation of 3-MCPD cannot be fundamentally prevented.

### SUMMARY

The present disclosure is contrived to solve the foregoing problem of the related art, and an object of the present disclosure is to provide a method for manufacturing soy sauce using bamboo salts, which enhance taste and flavor of the soy sauce. In addition, the soy sauce according to an exemplary embodiment of the present disclosure has high content of necessary amino acid in the soy sauce, and may fundamentally prevent generation of cancer-causing agent.

In order to achieve at least the above objects, in whole or in part, and in accordance with the purposes of the present disclosure, as embodied and broadly described, and in a general aspect, there is provided a method for manufacturing soy sauce using bamboo salt, the method comprising: steaming small beans for 3˜7 hours; cooling the steamed small beans at a temperature of 20˜40° C., after spreading the steamed small beans; mixing the cooled small beans with koji mold and peanut powder; forming a fermented soybean lump using the small beans mixed with the koji mold and the peanut powder, and tying an external portion of the fermented soybean lump using a rice straw; drying the formed fermented soybean lump in sunshine; fermenting the dried fermented soybean lump for 24˜48 hours while maintaining a humidity of 15˜35% and a temperature of 20˜40° C.; manufacturing a fermentation liquor by putting the fermented soybean lump in a jar, and by soaking the fermented soybean lump to be totally submerged in a mixed liquor of 100 parts by weight of bamboo salt water, 20˜40 parts by weight of Ulmus davidiana water, 15˜25 parts by weight of jujube fermentation liquor, and 5˜15 parts by weight of red ginseng extract; and completing the soy sauce, by separating the fermented soybean lump from the fermentation liquor, filtering floating matters, and by heating the fermentation liquor to be reduced by 70˜90% of an initial volume.

In some exemplary embodiments, 0.01˜0.03 parts by weight of the koji mold may be mixed with respect to 100 parts by weight of the small beans.

In some exemplary embodiments, the koji mold may be any one or two selected from Aspergillus oryzae and Aspergillus sojae.

In some exemplary embodiments, 10˜30 parts by weight of the peanut powder may be mixed with respect to 100 parts by weight of the small beans.

In some exemplary embodiments, the peanut powder may be characterized by being grinded after being fired in peanut oil at a temperature of 160˜180° C. for 10˜15 minutes.

In some exemplary embodiments, the bamboo salt water may be characterized by 100 parts by weight of water, 40˜60 parts by weight of bamboo salt, 20˜40 parts by weight of Mineral-fed Duck, and 60˜80 parts by weight of garlic, being cooled after being mixed and heated.

In some exemplary embodiments, the Ulmus davidiana water may be characterized by 100 parts by weight of water and 40˜60 parts by weight of Ulmus davidiana, being cooled after being mixed and heated.

In some exemplary embodiments, the jujube fermentation liquor may be a mixture of 100 parts by weight of jujube, 120˜150 parts by weight of sugar, 10˜20 parts by weight of kelp, and 0.01˜0.03 parts by weight of Lactobacillus bulgaricus.

In some exemplary embodiments, the jujube fermentation liquor may be characterized by being matured and fermented at a temperature of 20˜40° C. for 2˜4 months.

In some exemplary embodiments, the red ginseng extract may comprise an active constituent of ginsenoside removed of a hydroxyl group by being mixed with a hydrogen ion.

### Advantage

The method for manufacturing soy sauce using bamboo salts according to an exemplary embodiment of the present disclosure may enhance taste and flavor of the soy sauce. In addition, the soy sauce according to an exemplary embodiment of the present disclosure has high content of necessary amino acid in the soy sauce, and may fundamentally prevent generation of cancer-causing agent.

### BRIEF DESCRIPTION OF DRAWINGS

FIG. 1 is a flow chart illustrating an entire process according to an exemplary embodiment of the present disclosure.

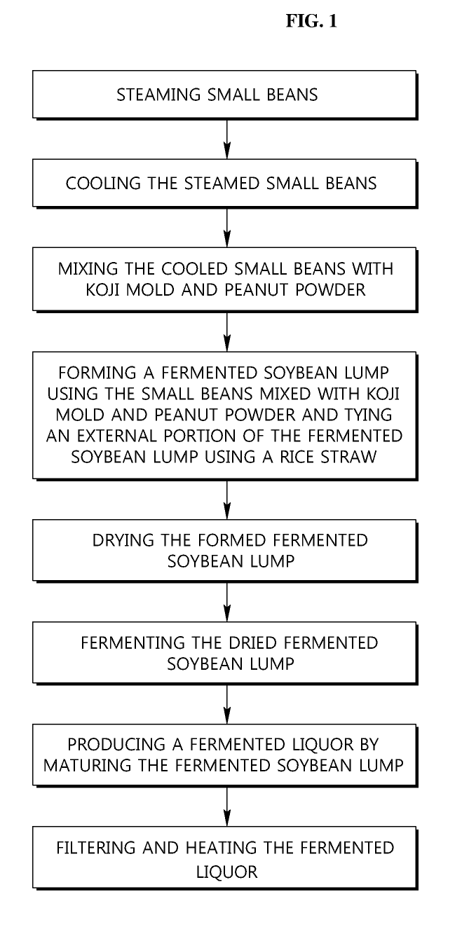

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, the described aspect is intended to embrace all such alterations, modifications, variations, and equivalents that fall within the scope and novel idea of the present disclosure. When it is determined that a detailed description about known function or structure relating to the present disclosure may evade the main point of the present disclosure, the detailed description may be omitted.

The terms including ordinal numbers such as “first” or “second” may be used for description of various elements. However, the elements shall not be limited by such the terms. The terms are used merely to distinguish a particular element from another element.

When a component is mentioned to be “connected” to or “accessing” another component, this may mean that it is directly connected to or accessing the other component, but it is to be understood that another component may exist in-between. On the other hand, when a component is mentioned to be “directly connected” to or “directly accessing” another component, it is to be understood that there are no other components in-between.

The terms mentioned herein are used merely for description of a particular exemplary embodiment. Thus, they are not intended to limit the scope of the present disclosure. The singular expression includes numeral expression thereof unless it has a clearly different meaning in the context. In the present disclosure, the terms such as “include” or “have” are state that there may be in existence of features, numbers, steps, functions, elements, components described herein, or compositions thereof. Therefore, they shall not be understood as to exclude the possibility of existence or addition of one or more other features, numbers, steps, functions, elements, components described herein, or compositions thereof.

The method for manufacturing soy sauce using bamboo salt according to an exemplary embodiment of the present disclosure may comprise: steaming small beans for 3˜7 hours; cooling the steamed small beans at a temperature of 20˜40° C., after spreading the steamed small beans; mixing the cooled small beans with koji mold and peanut powder; forming a fermented soybean lump using the small beans mixed with the koji mold and the peanut powder, and tying an external portion of the fermented soybean lump using a rice straw; drying the formed fermented soybean lump in sunshine; fermenting the dried fermented soybean lump for 24˜48 hours while maintaining a humidity of 15˜35% and a temperature of 20˜40° C.; manufacturing a fermentation liquor by putting the fermented soybean lump in a jar, and by soaking the fermented soybean lump to be totally submerged in a mixed liquor of 100 parts by weight of bamboo salt water, 20˜40 parts by weight of Ulmus davidiana water, 15˜25 parts by weight of jujube fermentation liquor, and 5˜15 parts by weight of red ginseng extract; and completing the soy sauce, by separating the fermented soybean lump from the fermentation liquor, filtering floating matters, and by heating the fermentation liquor to be reduced by 70˜90% of an initial volume.

<Steaming Small Beans>

This step is for steaming small beans for 3˜7 hours to destruct solid cellular walls and allow smooth introduction and decomposition activity of enzyme.

The small beans (Rhynchosia Nulubilis) bloom in July. The small beans may be harvested when the black and round seeds in a diameter of 5˜7 mm are ripen. The small beans cultivated by organic farming in red clay may be considered as the best products, of which nature of drug may be enhanced when cultivated with sulfur. The small beans have rich of fiber activating intestines and enzymes useful for human body. The small beans are also called as ‘drug beans’, because it is traditionally known to activate blood circulation and detoxicate.

When the steaming time is less than 3 hours, the cellular walls of the small beans are not completely destroyed, such that decomposition activity of enzyme may not be performed. When the steaming time is exceeding 7 hours, the protein structure of the small beans is reconstructed to be solid and indestructible.

<Cooling the Steamed Small Beans>

This step is for cooling the steamed small beans at a temperature of 20˜40° C., after spreading the steamed small beans. When the cooling temperature is less than 20° C., the propagation speed of the koji mold may be declined. When the cooling temperature is exceeding 40° C., the environment may become harder for the koji mold to propagate.

<Mixing the Cooled Small Beans with Koji Mold and Peanut Powder>

This step is for mixing the cooled small beans with koji mold and peanut powder, such that the cooled small beans may be well fermented and contain all kinds of essential amino acids. When the cooled small beans are mixed with the koji mold, the koji mold beneficial for human body propagates, such that the fermentation may be facilitated.

According to an exemplary embodiment of the present disclosure, 0.01˜0.03 parts by weight of the koji mold may be mixed with respect to 100 parts by weight of the small beans. When the content of the koji mold is less than 0.01 parts by weight, the fermentation may not be sufficiently performed. When the content of the koji mold is exceeding 0.03 parts by weight, the amount of fermentation may become larger than required to form a lump of fungus.

According to an exemplary embodiment of the present disclosure, the koji mold is any one or two selected from Aspergillus oryzae and Aspergillus sojae.

Meanwhile, the protein may be used as nutrients after being decomposed into amino acids in the body and absorbed. The nutritional value of protein may be determined by the types and amount contained in the protein. Here, an ‘essential amino acid’ or indispensable amino acid is an amino acid that cannot be synthesized de novo (from scratch) by the organism, and thus must be supplied in its diet.

The essential amino acids humans cannot synthesize are eight types of phenylalanine, valine, threonine, tryptophan, methionine, leucine, isoleucine, and lysine. If any one type of those essential amino acids is not supplied in the human body, it may cause problems in maintaining life.

Valine may be helpful for brain activity and emotional stability. It is essential in humans, meaning the body cannot synthesize it and thus it must be obtained from the diet. Human dietary sources are any proteinaceous foods such as meats, dairy products, soy products, beans and legumes.

Methionine is an essential amino acid in humans. Like other essential amino acids this means that a restriction of dietary intake of Methionine to zero will eventually lead to death. Additionally angiogenesis, the growth of new blood vessels, is better enabled by Methionine, acting beneficially if one is recovering, or suffering, from Parkinson, drug withdraw, schizophrenia, radiation, copper poisoning, asthma, allergies, alcoholism, or depression. On the other hand, over consumption of Methionine, as is typical in the diet but not vegan diet, is related to cancer growth in a number of studies.

Threonine is helpful for growth and immunity of children. Foods high in threonine include cottage cheese, poultry, fish, meat, lentils, Black turtle bean and Sesame seeds.

Lysine may function to help growth and digestion. Foods high in lysine include milk, cottage cheese, poultry, green beans and spinach.

Leucine is used in the liver, adipose tissue, and muscle tissue. Foods high in lysine include ham, cheese, corn, and beans.

Isoleucine is essential in humans, and is used in the biosynthesis of proteins. Even though this amino acid is not produced in animals, it is stored in high quantities. Foods that have high amounts of isoleucine include eggs, soy protein, seaweed, turkey, chicken, lamb, cheese, and fish.

Typtophan is needed to prevent illness or death. Tryptophan is a routine constituent of most protein-based foods or dietary proteins. It is particularly plentiful in chocolate, oats, dried dates, milk, yogurt, cottage cheese, red meat, eggs, fish, poultry, sesame, chickpeas, almonds, sunflower seeds, pumpkin seeds, buckwheat, spirulina, bananas, and peanuts.

Phenylalanine may be helpful for brain activity, and for reliving pain. Good sources of phenylalanine are eggs, chicken, liver, beef, milk, and soybeans. Other sources include spinach and leafy greens, tofu, amaranth leaves, and lupin seeds.

Among the essential amino acids, valine, threonine, methionine, leucine, isoleucine, and lysine may commonly be obtained from beans. Therefore, these six essential amino acids may be obtained from the small beans without difficulty.

On the other hand, tryptophan and phenylalanine are not obtainable from the beans. However, both of the tryptophan and the phenylalanine may be commonly obtained from the peanuts. Therefore, the soy sauce containing all of these eight essential amino acids may be manufactured, when the step of mixing the peanuts is included in the process according to the present disclosure.

According to an exemplary embodiment of the present disclosure, 10˜30 parts by weight of the peanut powder may be mixed with respect to 100 parts by weight of the small beans. Thereby, all types of essential amino acids may be contained in the cooled small beans, such that high TN index may be obtained when the soy sauce is manufactured. When the content of the peanut powder is less than 10 parts by weight with respect to 100 parts by weight of the small beans, the obtained amount of the tryptophan and the phenylalanine may be reduced. When the content of the peanut powder is exceeding 30 parts by weight with respect to 100 parts by weight of the small beans, the flavor of the peanut may become too strong to affect overall flavor of the soy sauce.

According to an exemplary embodiment of the present disclosure, the peanut powder may be grinded after being fired in peanut oil at a temperature of 160˜180° C. for 10˜15 minutes. Fat accounting for 50% of the peanut contains saturated fat, such that it may increase cholesterol level in the human body. Therefore, the fat in the peanut is required to be removed before being mixed with the cooled small beans.

For this reason, the peanut may be fried in the peanut oil. Because the fat in both the peanut oil and the peanut is formed with the same ingredient, the fat contained in the peanut is discharged into the peanut oil due to attraction generated between the peanut oil molecule and the fat molecule in the peanut, when the peanut is put into the peanut oil heated at a high temperature. Through this process, peanuts having no saturated fat may be obtained. Afterwards, the peanut powder may be obtained by grinding the fried peanut.

When the temperature of the peanut oil is less than 160° C., the peanut oil may not be introduced into the peanut. When the temperature of the peanut oil is exceeding 180° C., the peanut may be easily burned. When the time for frying the peanut is less than 10 minutes, the fat in the peanut may not be discharged. When the time for frying the peanut is exceeding 15 minutes, the peanut may be easily burned and the peanut oil may be introduced in the peanut.

<Forming a Fermented Soybean Lump Using the Small Beans Mixed with Koji Mold and Peanut Powder, and Tying an External Portion of the Fermented Soybean Lump Using a Rice Straw>

This step is for forming a fermented soybean lump using the small beans mixed with the koji mold and the peanut powder, and tying an external portion of the fermented soybean lump using a rice straw. Since the fermentation of soybean lump is aerobic fermentation, the fermentation may be accelerated as large as the area of the lump contacting oxygen. Here, the shape of the lump may be a rectangle. The reason of tying formed soybean lump using the rice straw is in order to introduce hay bacillus living in the rice straw into the fermented soybean lump. The hay bacillus may produce natural hydrololytic enzyme to facilitate fermentation of the soybean lump.

<Drying the Formed Fermented Soybean Lump>

This step is for drying a surface of the soybean lump in order to prevent introduction of harmful fungus. When the soybean lump is fermented before the surface of the lump is dried, the harmful fungus may be introduced in the soybean lump to intoxicate an interior of the soybean lump. The introduction and propagation of the harmful fungus may be prevented when a surface of the soybean lump is dried to be hardened.

<Fermenting the Dried Fermented Soybean Lump>

This step is for fermenting the dried fermented soybean lump for 24˜48 hours while maintaining a humidity of 15˜35% and a temperature of 20˜40° C. in order to facilitate propagation of beneficial fungus in the soybean lump. When the humidity is less than 15%, it may be difficult for the koji mold and the hay bacillus to propagate. When the humidity is exceeding 35%, harmful bacteria may be introduced from external sources, because the surface of the lump is softened by the humidity. In addition, when the temperature is less than 20° C., the propagation speed of the koji mold and the hay bacillus may be slowed down. When the temperature is exceeding 40° C., it may be difficult for the koji mold and the hay bacillus to propagate. When the fermentation time is less than 24 hours, some portions of the lump may not be fermented. When the fermentation time is exceeding 48 hours, all portion of the lump may have already been fermented, such that any further fermentation would be meaningless.

<Producing a Fermented Liquor by Maturing the Fermented Soybean Lump>

This step is for manufacturing a fermentation liquor by putting the fermented soybean lump in a jar, and by soaking the fermented soybean lump to be totally submerged in a mixed liquor of 100 parts by weight of bamboo salt water, 20˜40 parts by weight of Ulmus davidiana water, 15˜25 parts by weight of jujube fermentation liquor, and 5˜15 parts by weight of red ginseng extract.

According to an exemplary embodiment of the present disclosure, the bamboo salt water may be 100 parts by weight of water, 40˜60 parts by weight of bamboo salt, 20˜40 parts by weight of Mineral-fed Duck, and 60˜80 parts by weight of garlic, being cooled after being mixed and heated.

The bamboo salt may be manufactured by repeating the process of chopping solar salt into a bamboo tube and burning with pine wood eight times, and by burning with pine resin at the ninth time. It is known that the bamboo salt is beneficial for detoxication, lifeblood, anti-inflammation, cell reproduction, radical reform, and anti-bacterial activity. When the content of the bamboo salt is less than 40 parts by weight, the salty taste of the soybean sauce may be diluted. When the content of the bamboo salt is exceeding 60 parts by weight, the taste of the soybean sauce may become too salty.

The mineral-fed duck is a duck fed with fodder mixed with sulfur, such that most of toxic ingredients are removed through detoxication of the duck and drug ingredients are accumulated in the body of the duck. The Mineral-fed Duck is known as beneficial for care and prevention of various diseases, and vigorousness as well. When the content of the mineral-fed duck is less than 20 parts by weight, the efficacy of the mineral-fed duck may not be revealed. When the content of the mineral-fed duck is exceeding 40 parts by weight, smell of the duck may stink.

The garlic may cause anti-bacterial effect in the body. In addition, it has been known that the scordinin ingredient contained in the garlic has anticancer effect. When the content of the garlic is less than 60 parts by weight, the anti-bacterial effect may not be sufficiently caused. When the content of the garlic is exceeding 80 parts by weight, the strong flavor of the garlic may stimulate.

According to an exemplary embodiment of the Ulmus davidiana water may be 100 parts by weight of water and 40˜60 parts by weight of Ulmus davidiana, being cooled after being mixed and heated.

The scientific name of the Ulmus davidiana is ‘Ulmus adavidiana var’, referring to a root skin of an elm tree. The Ulmus davidiana is known as beneficial for various stomach and intestines disease.

When the content of the Ulmus davidiana is less than 40 parts by weight with respect to 100 parts by weight of water, the concentration of the Ulmus davidiana water is too low to sufficiently reveal the efficacy of the Ulmus davidiana. When the content of the Ulmus davidiana is exceeding 60 parts by weight, a respectable amount of water may be evaporated before the extraction of the Ulmus davidiana ingredient during the heating process, such that the manufacturing time may become unnecessarily longer, because the water is required to be supplied again. When the content of the Ulmus davidiana water manufactured by the above process is less than 20 parts by weight, the efficacy of the Ulmus davidiana may not be sufficiently revealed. When the content of the Ulmus davidiana water manufactured by the above process is exceeding 40 parts by weight, the viscosity of the soybean sauce may become too thick and the color may become unclear.

According to an exemplary embodiment of the present disclosure, the jujube fermentation liquor may be a mixture of 100 parts by weight of jujube, 120˜150 parts by weight of sugar, 10˜20 parts by weight of kelp, and 0.01˜0.03 parts by weight of Lactobacillus bulgaricus, being matured and fermented at a temperature of 20˜40° C. for 2˜4 months.

The jujube contains plenty of protein, essential amino acids, and mineral elements. The jujube is also a good source of calcium and irons. The jujube is also known as beneficial for various stomach and intestines disease, and liver as well. It has been also told that the jujube has no toxic to have no side effect, and therefore it is good for health to constantly taking the jujube.

When the content of the sugar per 100 parts by weight of the jujube is less than 120 parts by weight, the fermentation time may become longer and the jujube may be spoiled before being fermented, because the sugar cannot reach an interior of the jujube containing almost no water. When the content of the sugar is exceeding 150 parts by weight, the sweet taste may become too strong to spoil the taste and flavor of the soybean sauce.

Here, the kelp may be mixed therein to delay isomerization from fructose to glucose, so as to produce fermentation liquor having high rate of fructose, which is beneficial for diabetes and cancer patients. When the content of the kelp is less than 10 parts by weight, the efficacy of the kelp may not be sufficiently revealed. When the content of the kelp is exceeding 20 parts by weight, the flavor of the kelp may become too strong to spoil the taste and flavor of the soybean sauce.

According to an exemplary embodiment of the present disclosure, 0.01˜0.03 parts by weight of Lactobacillus bulgaricus may be mixed in the jujube fermentation liquor. When the content of the Lactobacillus bulgaricus is less than 0.01 parts by weight, the fermentation time may be delayed. When the content of the Lactobacillus bulgaricus is exceeding 0.03 parts by weight, the amount of fermentation may increase too much to generate exceeding amount of floating materials. When the fermentation temperature is less than 20° C., the activity of lactobacillus may be degraded. When the fermentation temperature is exceeding 40° C., the lactobacillus may be over-activated to cause rapid internal change. When the period of maturing and fermentation is less than 2 months, the fermentation may not be sufficiently performed. When the period of maturing and fermentation is exceeding 4 months, the overall manufacturing period may be delayed to cause degradation of productivity.

According to an exemplary embodiment of the present disclosure, the red ginseng extract may comprise an active constituent of ginsenoside removed of a hydroxyl group by being mixed with a hydrogen ion.

A red ginseng is made by steaming (by means of steam of other methods), heating, and drying an undried fresh ginseng, using a ginseng (Panax ginseng C.A. Meyer) as a raw material. An outer surface of the red ginseng is colored in light yellowish brown or reddish brown, translucent, and has longitudinal creases and thin root traces. The red ginseng has a characteristic scent. A taste of the red ginseng is a little sweet at first time and a little bitter at later times. The red ginseng contains niacin, sodium, protein, saccharide, retinol, beta-carotene, vitamin A, vitamin B1, vitamin B2, vitamin B6, vitamin C, vitamin E, vitamin E, dietary fiber, zinc, folate, phosphorus, lipid, iron, potassium, calcium, cholesterol, ash, and various kinds of saponin. These active ingredients help our bodies to generate new physiologically active ingredients. Furthermore, the red ginseng is conducive to refreshment, strengthening immunity, and invigorating vital energy. The red ginseng has an anti-oxidative effect, too.

According to an exemplary embodiment of the present disclosure, the hydroxyl group (—OH group) combined with ginsenoside may be removed. The ginsenoside is a typical active ingredient of the red ginseng, which is roughly divided into a Protopanaxadiol saponin (hereinafter referred to as ‘PPD’) and a Protopanaxatriol saponin (hereinafter referred to as ‘PPT’). The hydroxyl group (—OH group) is included in both of the PPD and the PPT. When the PPD and the PPT are introduced in the human body, a rumen microorganism called ‘prevotella oris’ may serve to remove the hydroxyl group (—OH group) from the PPD and the PPT. At this moment, the PPD and the PPT may be converted into a special saponin that has higher body absorption rate. However, there also exists a physical constitution that has no prevotella oris in the intestines. In this case, the body absorption rate of the PPD and the PPT is extremely low, because the hydroxyl group (—OH group) is not separated from the PPD and the PPT.

Therefore, in order to increase the body absorption rate of a physical constitution having no has no prevotella oris in the intestines, a method to artificially remove the hydroxyl group (—OH group) included in the PPD and the PPT structure. By such manufacturing method, coffee seed may be soaked in the red ginseng extract including an active constituent of ginsenoside removed of a hydroxyl group.

A method for manufacturing the red ginseng extract including an active constituent of ginsenoside removed of a hydroxyl group may include a step of manufacturing a red ginseng liquid, a step of obtaining a red ginseng sap, and a step of obtaining red ginseng extract.

The step of manufacturing a red ginseng liguid may include mixing a mixture of dried red ginseng roots and dried red ginseng rootlets with water and heating the mixture. The dried red ginseng may include 100 parts by weight of a dried red ginseng root and 40˜45 parts by weight of a dried red ginseng rootlet. The red ginseng powder in shape of small particles is soluble in water and has a wide surface area, such that active ingredients in the red ginseng powder may be readily emitted into the water. Thereby, the time for manufacturing the red ginseng liquid may be shortened. The efficacy and sweetness of the active ingredients may be most excellentized when a dried red ginseng root 100 parts by weight is mixed with a dried red ginseng 40˜45 parts by weight. A mixing proportion between the dried red ginseng and the water may be 1:2˜4. In addition, the time for extracting the red ginseng liquid may be prolonged when a heating temperature is under 80° C. The active ingredients contained in the red ginseng may be destroyed when the heating temperature is exceeding 90° C. In addition, the red ginseng liquid may not be sufficiently extracted when heating time is less than 16 hours. The active ingredients in the red ginseng may be degenerated when the heating time is exceeding 20 hours, because the moisture is evaporated more than required.

The step of obtaining the red ginseng sap may be a step of obtaining a red ginseng sap, by centrifuging the red ginseng liquid (that has been manufactured by heating the dried red ginseng powder and water) to remove a red ginseng solid. When the red ginseng liquid is centrifuged, the red ginseng liquid may be divided into a red ginseng sap (supernatant) and a red ginseng solid (precipitate). The red ginseng sap containing a lot of active ingredients may be obtained, while the red ginseng solid may be removed.

The step of obtaining the red ginseng sap may include centrifuging the red ginseng liquid at least twice to remove the red ginseng solid. In some exemplary embodiments, the centrifugation may be repeated by 10˜14 times. A high-purity red ginseng liquid may be obtained by repeating the centrifugation by 10˜14 times.

The step of obtaining the red ginseng extract may be a step of obtaining the red ginseng extract by allowing the red ginseng sap to pass through a semipermeable membrane at a room temperature. When the red ginseng sap passes through the semipermeable membrane, the moisture can pass through, but the active ingredients contained in the red ginseng sap cannot pass through the semipermeable membrane. The active ingredients remaining in the semipermeable membrane may be obtained as the red ginseng extract, while the moisture that passed through the semipermeable membrane is removed.

According to an exemplary embodiment of the present disclosure, the method for manufacturing the red ginseng extract may further include introducing a hydrogen ion from an external source to a semipermeable membrane through a hydrogen ion supply channel. When the hydrogen ion is supplied to the semipermeable membrane, the hydroxyl group (—OH group) combined with ginsenoside may be removed, without going through the high-temperature processing.

According to an exemplary embodiment of the present disclosure, the method for manufacturing the red ginseng extract may further include irradiating ultraviolet rays. When ultraviolet rays are irradiated to the red ginseng sap, bacteria residing in the red ginseng sap may be removed. The red ginseng sap may be irradiated with ultraviolet rays to be sterilized, during being dried at a room temperature.

According to an exemplary embodiment of the present disclosure, the method for manufacturing the red ginseng extract may further include vibro-isolating the dried red ginseng extract and the dried semipermeable membrane for 1˜3 hours. When the semipermeable membrane combined with the red ginseng extract is vibrated, the red ginseng extract may be completely isolated from the semipermeable membrane. The isolated amount may be not sufficient, when the vibro-isolating time is less than 1 hour. The vibro-isolating time may be unnecessarily prolonged to the extent that no more isolation can be performed, when the vibro-isolating time is exceeding 3 hours.

The effectiveness of the red ginseng may be revealed at its best, when the fermented soybean lump is soaked in the mixed liquor containing 5˜15 parts by weight of red ginseng extract including an active constituent of ginsenoside removed of a hydroxyl group and 100 parts by weight of bamboo salt water. When the content of the red ginseng extract is less than 5 parts by weight, the effectiveness of the red ginseng may not be sufficiently revealed. When the content of the red ginseng extract is exceeding 15 parts by weight, the genuine flavor of the soy sauce may be lost due to the taste and flavor of the red ginseng extract.

<Filtering and Heating the Fermentation Liquor>

This step is for completing the soy sauce, by separating the fermented soybean lump from the fermentation liquor, filtering floating matters, and by heating the fermentation liquor to be reduced by 70˜90% of an initial volume. When the fermentation liquor is heated to be reduced less than 70% of the initial volume, the soy sauce may become too salty and sticky. When the fermentation liquor is heated to be reduced exceeding 90% of the initial volume, the soy sauce may not function as a seasoning, because the salty taste of the soy sauce is not sufficiently revealed.

Hereinafter, some preferred exemplary embodiments and comparative embodiments are suggested in order to facilitate understanding of the present disclosure. However, the following exemplary embodiments are intended to be illustrative, and not to limit the scope of the claims. Many alternatives, modifications, variations, and equivalents will be apparent to those skilled in the art. The features, structures, methods, and other characteristics of the exemplary embodiments described herein may be combined in various ways to obtain additional and/or alternative exemplary embodiments within an equivalent scope. Therefore, the technical scope of the rights for the present disclosure shall be decided by the appended claims and equivalents thereof.

### Exemplary Embodiment

The soy sauce according to an exemplary embodiment of the present disclosure was completed by steaming small beans for 5 hours, cooling the steamed small beans at a temperature of 30° C., after spreading the steamed small beans, mixing 0.02 parts by weight of Aspergillus oryzae and 20 parts by weight of peanut powder grinded after being fired in peanut oil at a temperature of 170° C. for 12 minutes with respect to 100 parts by weight of the cooled small beans, forming a fermented soybean lump using the small beans mixed with the Aspergillus oryzae and the peanut powder, and tying an external portion of the fermented soybean lump using a rice straw, drying the formed fermented soybean lump in sunshine, fermenting the dried fermented soybean lump for 36 hours while maintaining a humidity of 25% and a temperature of 30° C., manufacturing a fermentation liquor by putting the fermented soybean lump in a jar, and by soaking the fermented soybean lump to be totally submerged in a mixed liquor of 100 parts by weight of bamboo salt water, 30 parts by weight of Ulmus davidiana water (100 parts by weight of water and 50 parts by weight of Ulmus davidiana, being cooled after being mixed and heated), 20 parts by weight of jujube fermentation liquor (a mixture of 100 parts by weight of jujube, 140 parts by weight of sugar, 30 parts by weight of kelp, and 0.02 parts by weight of Lactobacillus bulgaricus, being matured and fermented at a temperature of 26° C. for 3 months), and 10 parts by weight of red ginseng extract (including an active constituent of ginsenoside removed of a hydroxyl group by being mixed with a hydrogen ion), and completing the soy sauce, by separating the fermented soybean lump from the fermentation liquor, filtering floating matters, and by heating the fermentation liquor to be reduced by 80% of an initial volume.

### Experimental Example

The soy sauce manufactured in the exemplary embodiment radiated delicate flavors of peanut and jujube, dark-brown colored, and having 23% of salinity.

In order to test flavor, taste, and color of the soy sauce according to an exemplary embodiment of the present disclosure, 10 adult men and 10 adult women conducted a comparative sensory test. The result is shown in the following [TABLE 1].

TABLE 1

| | VERY | | | | | | | |
|---|---|---|---|---|---|---|---|---|
| | GOOD | | GOOD | | NORMAL | | POOR | |
| Section | MAN | WOMAN | MAN | WOMAN | MAN | WOMAN | MAN | WOMAN |
| Salty Taste | 4 | 5 | 5 | 4 | 1 | 1 | | |
| Flavor (Smell) | 4 | 5 | 5 | 3 | 1 | 2 | | |
| Color | 5 | 5 | 4 | 3 | 1 | 2 | | |
| Overall | 4 | 5 | 4 | 4 | 2 | 1 | | |
| Preference | | | | | | | | |

As shown in the above [TABLE 1], the soy sauce manufactured by the method according to an exemplary embodiment of the present disclosure showed outstanding quality in all aspects including taste, flavor, color, and the overall preference as well. Therefore, it may be expected that the soy sauce according to an exemplary embodiment of the present disclosure may satisfy various consumers of all age, sex, and nationality.

1. A method for manufacturing soy sauce using bamboo salt, the method comprising:
steaming small beans for 3˜7 hours;
cooling the steamed small beans at a temperature of 20˜40° C., after spreading the steamed small beans;
mixing the cooled small beans with koji mold and peanut powder;
forming a fermented soybean lump using the small beans mixed with the koji mold and the peanut powder, and tying an external portion of the fermented soybean lump using a rice straw;
drying the formed fermented soybean lump in sunshine;
fermenting the dried fermented soybean lump for 24˜48 hours while maintaining a humidity of 15˜35% and a temperature of 20˜40° C.;
manufacturing a fermentation liquor by putting the fermented soybean lump in a jar, and by soaking the fermented soybean lump to be totally submerged in a mixed liquor of 100 parts by weight of bamboo salt water, 20˜40 parts by weight of Ulmus davidiana water, 15˜25 parts by weight of jujube fermentation liquor, and 5˜15 parts by weight of red ginseng extract; and
completing the soy sauce, by separating the fermented soybean lump from the fermentation liquor, filtering floating matters, and by heating the fermentation liquor to be reduced by 70˜90% of an initial volume.

2. The method of claim 1, wherein 0.01˜0.03 parts by weight of the koji mold is mixed with respect to 100 parts by weight of the small beans.

3. The method of claim 1, wherein the koji mold is any one or two selected from Aspergillus oryzae and Aspergillus sojae.

4. The method of claim 1, wherein 10˜30 parts by weight of the peanut powder is mixed with respect to 100 parts by weight of the small beans.

5. The method of claim 1, wherein the peanut powder is characterized by being grinded after being fired in peanut oil at a temperature of 160˜180° C. for 10˜15 minutes.

6. The method of claim 1, wherein the bamboo salt water is characterized by 100 parts by weight of water, 40˜60 parts by weight of bamboo salt, 20˜40 parts by weight of Mineral-fed Duck, and 60˜80 parts by weight of garlic, being cooled after being mixed and heated.

7. The method of claim 1, wherein the Ulmus davidiana water is characterized by 100 parts by weight of water and 40˜60 parts by weight of Ulmus davidiana, being cooled after being mixed and heated.

8. The method of claim 1, wherein the jujube fermentation liquor is a mixture of 100 parts by weight of jujube, 120˜150 parts by weight of sugar, 10˜20 parts by weight of kelp, and 0.01˜0.03 parts by weight of Lactobacillus bulgaricus.

9. The method of claim 1, wherein the jujube fermentation liquor is characterized by being matured and fermented at a temperature of 20˜40° C. for 2˜4 months.

10. The method of claim 1, wherein the red ginseng extract comprises an active constituent of ginsenoside removed of a hydroxyl group by being mixed with a hydrogen ion.
